(19) United States
(12) Patent Application Publication
(10) Pub. No.: US 2016/0253610 A1
(43) Pub. Date: Sep. 1, 2016

(54) SYSTEM FOR AUTOMATED RANKING AND SORTING IN A DATABASE USING PREDEFINED USER ASSIGNED ATTRIBUTES

(71) Applicant: Kamal Kalra, Somerset, NJ (US)

(72) Inventor: Kamal Kalra, Somerset, NJ (US)

(21) Appl. No.: 15/056,704

(22) Filed: Feb. 29, 2016

Related U.S. Application Data
(60) Provisional application No. 62/126,098, filed on Feb. 27, 2015.

(51) Int. Cl. G06Q 10/06; G06F 3/0482; G06F 17/30; G06F 3/0484

(52) U.S. Cl. CPC G06Q 10/06311; G06F 3/04842; G06F 3/0482; G06F 17/3053

(57) ABSTRACT

A system comprising a network of computers programmed to create supervisory accounts and worker accounts, receive requests to create tasks and assign them to users of worker accounts, receive requests to assign attributes to tasks, and sort the tasks based on the attributes.

### PRIORITY CLAIM

This application claims priority to U.S. Provisional Application Ser. No. 62/126,098, filed Feb. 27, 2015. The above references application is incorporated herein by reference as if restated in full.

### BACKGROUND

One of the greatest technological problems in network-based task allocation systems is the inability to systematically rank tasks based on task parameters in a way that provides a degree of user control over the rules or standards by which systematic ranking is effectuated. Another technological problem is the absence of an effective user interface that facilitates the assignation of tasks to users in a network while preserving the visualization of ranking decisions.

### SUMMARY

The embodiments described provide a technological solution to the above described technological problems. The embodiments may include A system comprising a network of computers, each having a computer-readable storage memory, a first display device, and one or more input devices. The computers may be programmed to: graphically display task windows, receive user requests via the one or more input devices to create tasks and graphically display them in task panels in the task windows. The computers may also be programmed to receive user assignations of attributes and associate those attributes with the tasks. The tasks may be assigned to different users and sorted based on the attributes associated with them.

In one aspect, the system is a task management platform. The system may be implemented as a web application, a native desktop application, or a mobile application for smart phones or tablets. It may be used by one or more users. One user may be described as selecting or requesting., but it should be understood that one user may select on one occasion, and another user may request on another occasion.

In another aspect, the system comprises a set of one or more Tasks. These Tasks may be created and edited by a user of the system. In one embodiment, a Task may be assigned to a user by a supervisory user. In another embodiment, a Task may be assigned to a user by the system based on calculations or determinations made by the system.

In one aspect, the system comprises a Task Window, a graphical interface that may be navigated by a user and used to send commands to the system. In one embodiment, each user may have his or her own Task Window which displays Tasks. In another embodiment, a user's Task Window only displays Tasks assigned to that user or to a group of co-users in which that user is assigned or organized. In yet another embodiment, a user's Task Window displays the Tasks assigned to that user only.

In another aspect, the system comprises a set of one or more Attributes. These Attributes may be created and edited by a user of the system. An Attribute may be attributed to a given Task by a user. In one embodiment, Attributes may be graphically displayed on or adjacent to a representation of the Task in the Task Window.

In one version, an Attribute may be graphically represented on a task panel associated with a Task. The task panel may be displayed in the Task Window. By selecting a given Attribute on a given task panel, the user commands the system to attribute the Attribute to the Task. The identify of the user assigned to a given Task may be displayed adjacent to or on the task panel.

A Priority Attribute may be attributed to a Task by a user based on its importance. In one version, the user may attribute a given Task as having a High, Medium, or Low Priority. In another version, the user may enter or select a number that corresponds to a priority level. The number may be situated on a scale of one to ten.

In one embodiment, the system may comprise a Ranking List. The Ranking List is a ranked series of the Attributes treated by the system. Attributes that have a higher rank are placed in an earlier position in The Ranking List than Attributes that have a lower rank. It is possible that some Attributes are ranked equally, and therefore occupy the same position.

The system may comprise one or more Rank Regimes. A Rank Regime is an instance of the Ranking List. Rank Regimes may be predetermined by the system or created and/or modified by the user.

The system may comprise a Ranking List Window, in which a Rank Regime is displayed. In one version, users may create or modify a Rank Regime by entering numbers or letters indicating in rank fields on or adjacent to each Attribute, where the number or letter indicate how an Attribute is ranked in relation to others. In another version, users may drag graphical representations of Attributes so as to graphically display the desired order. Rank Regimes may be saved so that they may be loaded at and applied at another time.

The system may apply a Rank Regime to one or more Tasks. This may be done automatically as new Tasks are created. In another embodiment, the system comprises a sort command. Upon receiving the sort command from the user, the system will apply an Rank Regime. In yet another embodiment, the user can select which Rank Regime he or she wishes the system to apply. In one version, upon receiving a selection of a Rank Regime from the user, the system will apply the Rank Regime. In another version, the system will not apply the Rank Regime until both a selection of a Rank Regime and the sort command is received by the system from the user.

Once a Rank Regime is applied, the Tasks are arranged in order based on their Attributes. Tasks attributed with higher ranked Attributes will be ordered earlier in a series than Tasks with lower ranked Attributes. If multiple Tasks have one or more Attributes that are ranked equally high, then the system may order the Tasks based on the ranks of other Attributes attributed to the Tasks. If multiple Tasks have identical Attributes, then the system may order the Tasks alphabetically and/or by one or more Task Parameters.

In one embodiment, the system can determine the ranking of Attributes by user activity. When a user completes a Task, the Attribute(s) attributed to that Task are increased in rank.

In one aspect, the system may assign Tasks to users based on their position in the series. Once a user completes a Task, the system may assign the next Task in the series.

In one aspect, the system or a supervisory user may label users. Users may be given High, Medium, or Low Priority Labels. High Priority workers presumably have greater credibility in completing work correctly. In one version, once a user with a given Priority Label completes a task, the system may assign that user the next task with the same Priority Attribute. In another version, if no tasks with a same Priority Attribute remain, the system may assign that user the next task with the next Priority Attribute.

Once the ranks of tasks are determined, the system may also use one or more standard sorting algorithms, including Simple Sort, Efficient Sort, Bubble Sort, and/or Distribution Sort. In one version, the system may simultaneously determine the rank of a task based on its Attributes and sort the task with respect to other tasks that have already been sorted.

### BRIEF DESCRIPTION OF THE DRAWINGS

FIG. 1 shows an exemplary computer system.

FIG. 2 shows an exemplary Action Permissions Chart.

FIG. 3 shows an exemplary Task Window.

FIG. 4 shows an exemplary Ranking List.

FIG. 5 shows exemplary steps for creating a Ranking List

FIG. 6 shows exemplary steps for ordering Tasks based on Attributes.

FIG. 7 shows exemplary steps for assigning Tasks.

FIG. 8 shows exemplary steps for assigning Tasks.

FIG. 9 shows exemplary steps for assigning Rank to Tasks.

FIG. 10 shows exemplary steps for assigning Ranks to Tasks.

FIG. 11 shows exemplary steps for assigning Ranks to Tasks.

FIG. 12 shows exemplary steps for ordering Tasks.

### DETAILED DESCRIPTION

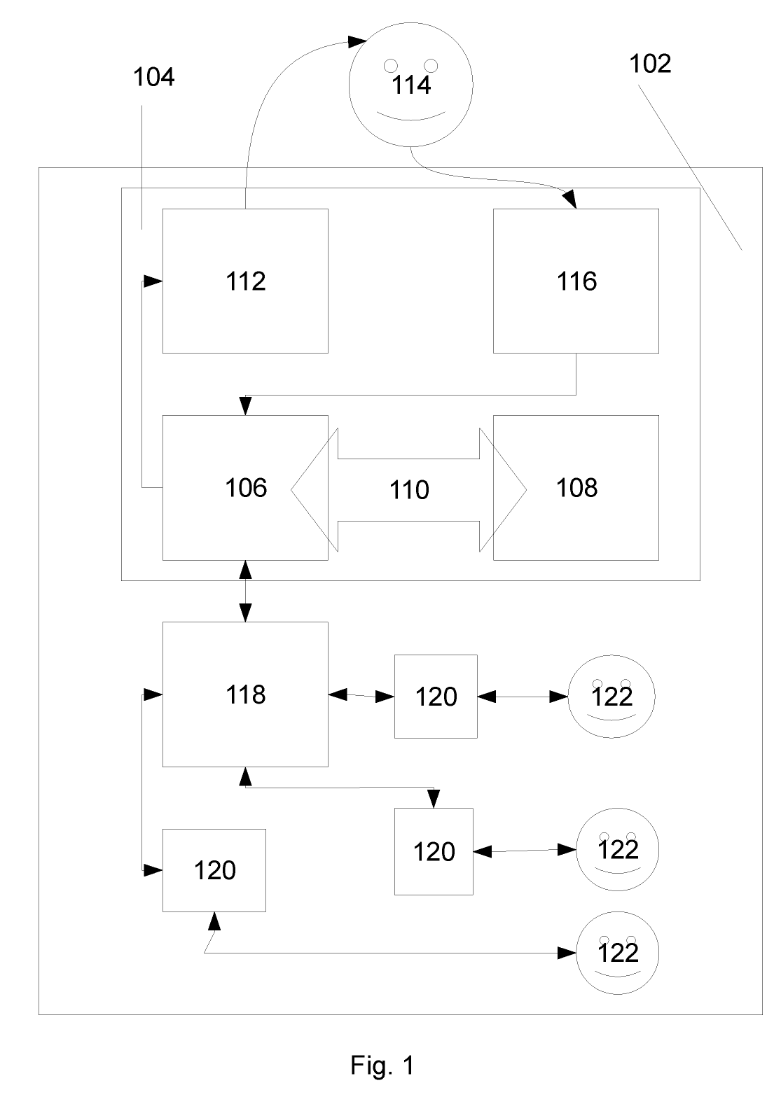

The system is a task management platform. As show in FIG. 1, a computer system 102 for performing the embodiments described herein may comprise one or more programmed computers 104. Each programmed computer may comprise a processor 106 engaged with a computer memory 108 to execute instructions 110 loadable onto and then provided by the computer memory. The computer system may also comprise one or more display devices 112 to graphically display to a user 114 the embodiments described herein, and one or more input devices 116 to receive selection, indication, and movement instructions from the user. The computer system may be embodied by a traditional desktop computer, a laptop, or mobile device. In yet another embodiment, the computer system accesses a network 118, which may connect it to one or more other programmed computers 120 and users 122. In yet another embodiment, computer memory 108 may additionally comprise a database.

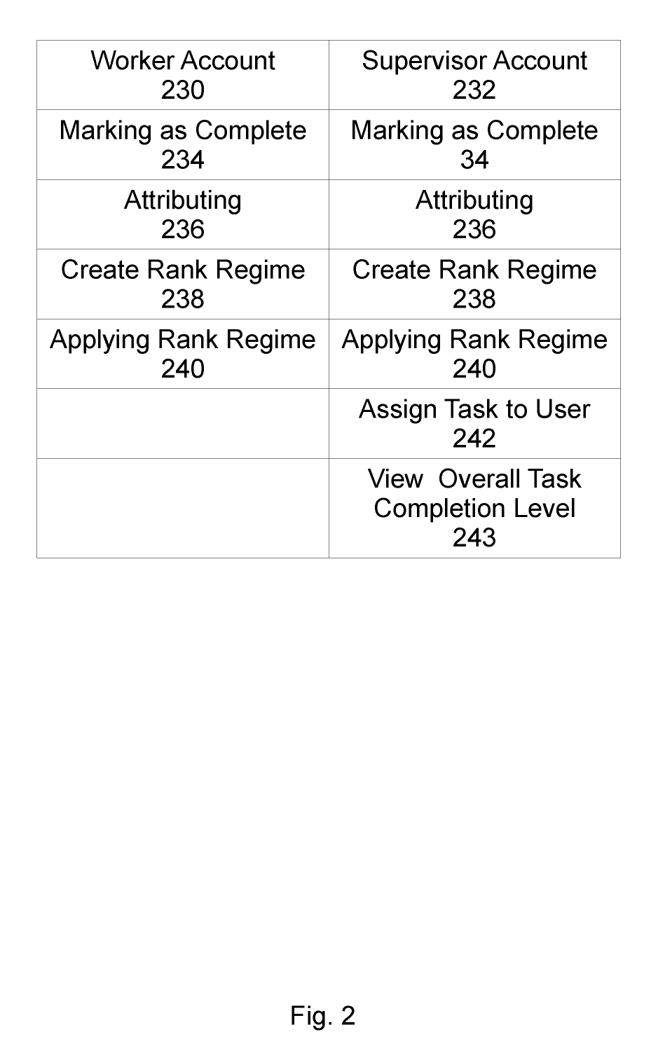

Users may be provided different action sets based on their account type. An action is a command or selection that a user can execute in the system. As shown in FIG. 2, user account types may include a worker accounts 230 and supervisor accounts 232. A user with a worker account may be provided with an action set comprising: marking a task as complete 234, attributing Attributes to one or more Tasks 236, and creating a Rank Regime 238, and applying a Rank Regime 240. The supervisory user may be provided an action set comprising the worker account's action set in addition to a supervisory action set. This supervisory action set may include assigning a Task to a user 242. Finally, a supervisory user may view the overall progress of a project by accessing a graphical display representing the tasks that are complete separately from the tasks that are incomplete 243.

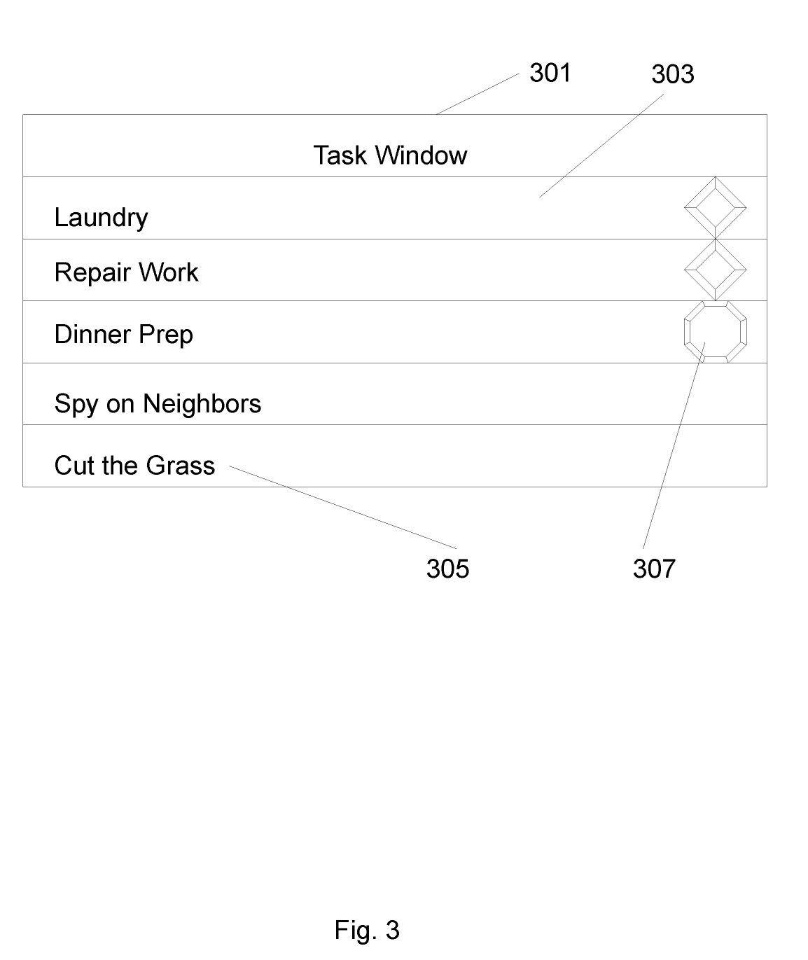

As shown in FIG. 3, the system may comprise a Task Window 301, which may be displayed on the display device. The Task Window may display one or more Task Panels 303, each representing a Task. The Task may be identified by a Text Description 305. Attributes 307 attributed to a Task may be represented on or adjacent to the Task Panel representing the Task. The system may display graphic representations of Attributes. These Attributes may include Priority Attributes, such as High, Medium, and Low Priority Attributes. A user may attribute an Attribute to a Task by selecting a graphic representation of the Attribute. The Attribute is then displayed on the Task's Task Panel. In one embodiment, the Attribute is not displayed on the task panel itself, but on a separate overlapping panel.

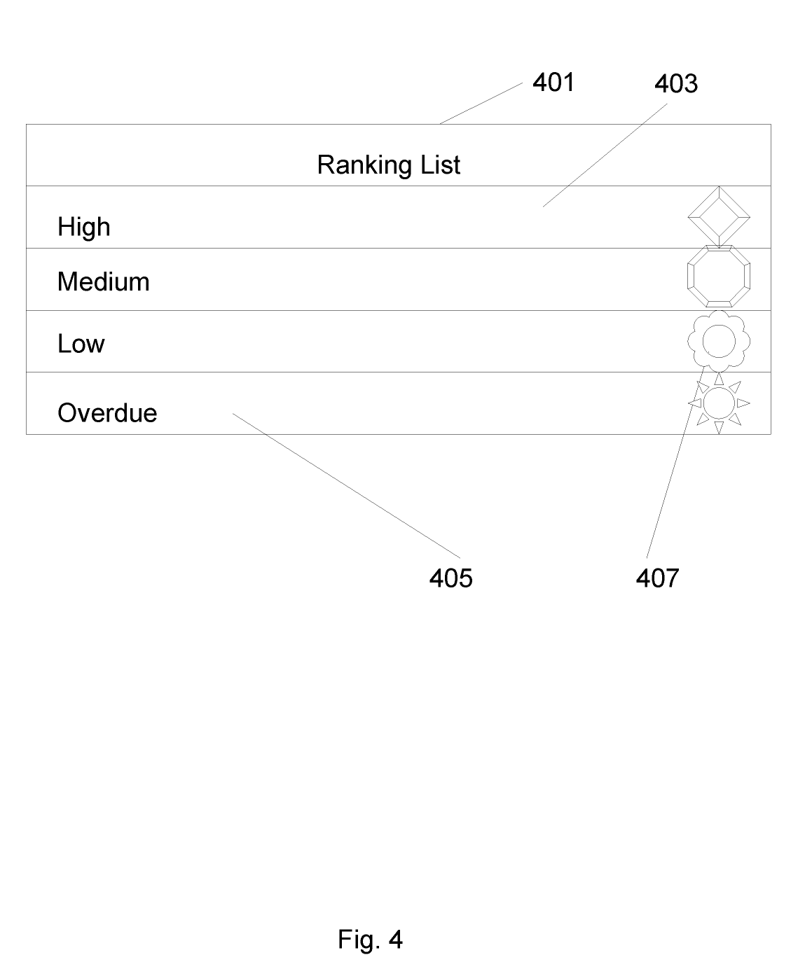

As shown in FIG. 4, the system may display a Ranking List 401. The Ranking List may display the one or more Attributes 403 treated by the system. The Attributes may be represented by a Text Region 405 and an image 407.

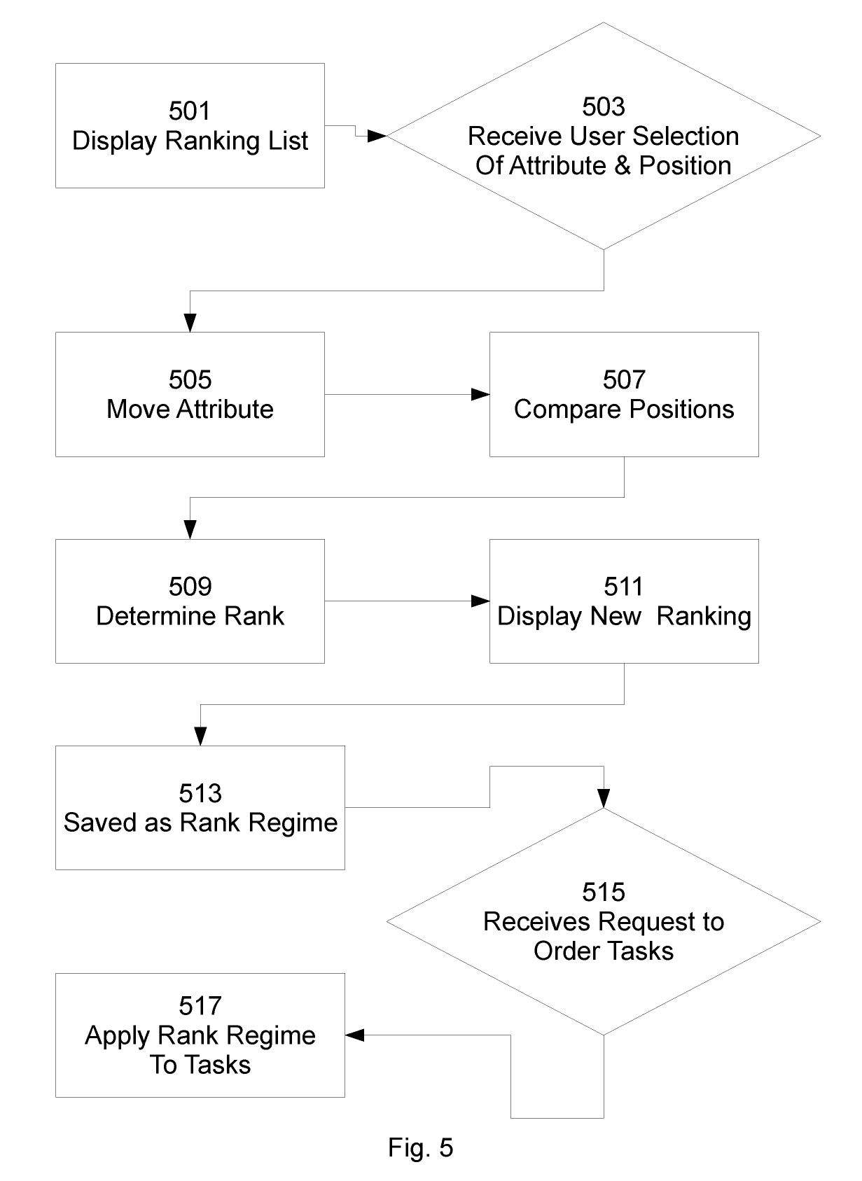

As shown in FIG. 5, the system may first display 501 the Ranking List and one or more Attributes in the display device. If the system receives 503 a user selection of an Attribute and a user selection of a graphical position, then that Attribute may be moved 505 by the system to that new graphical position. The graphical position may be compared 507 to one or more other graphical positions to determine 509 the new rank of Attributes. Graphical Positions have x and y coordinates. One of those coordinates may be selected and rank will be determined based on the order from least to greatest of the instances of those coordinates. The system will then display 511 the new order of Attributes. This new order may be saved 513 as a Rank Regime. If the system receives 515 a user request to order Tasks, the the system may apply 517 the Rank Regime to the one or more Tasks in the Task Window.

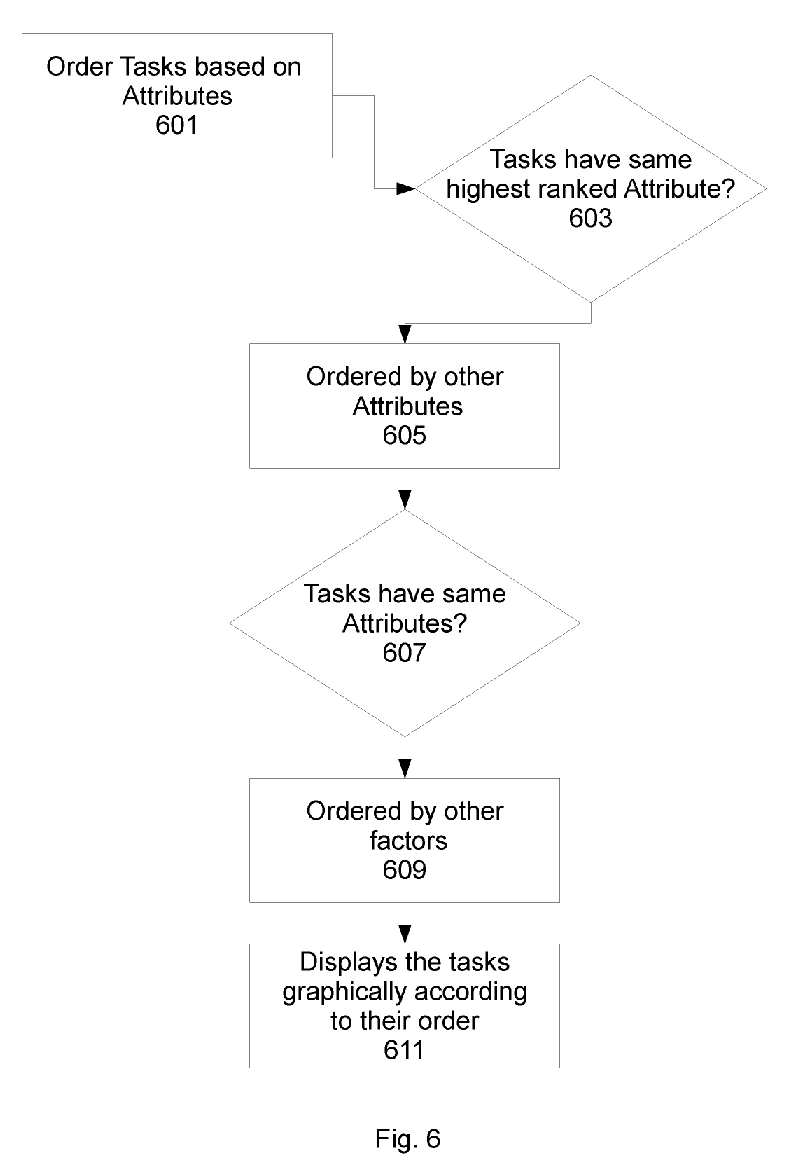

FIG. 6 shows the steps in which the system applies a Rank Regime. The system may order Tasks based on the Attributes attributed to them 601. If Tasks have the same highest (or lowest) ranked Attribute 603, they are ordered by other Attributes attributed to them 605. If they have the same Attributes 607, then they are ordered by other factors 609, such as as alphabetically or by due date. Then the system displays the tasks graphically according to their order 611.

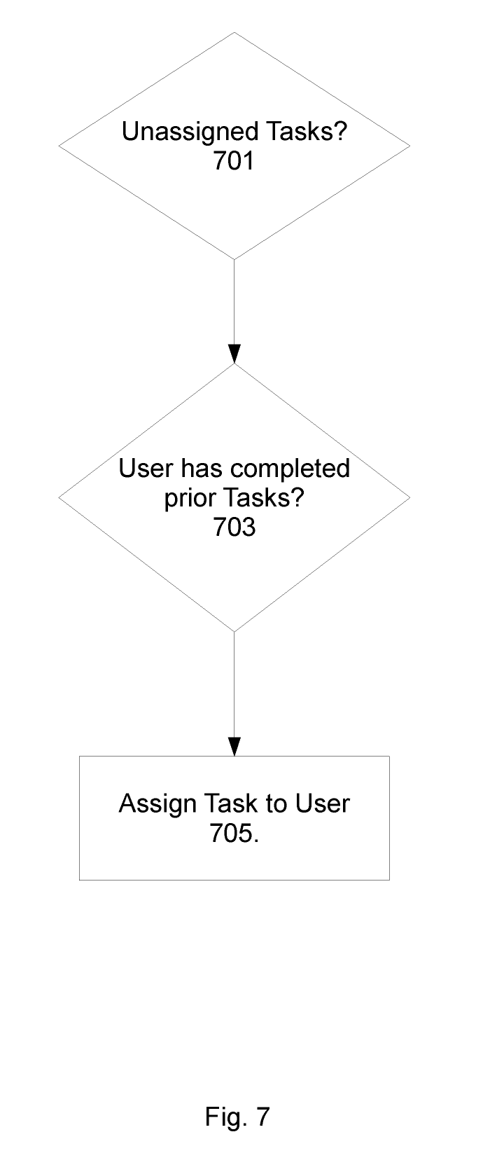

As shown in FIG. 7, the system may assign one or more Tasks to users based on their order or position in the series. If a task is unassigned 701, the system may assign it to a user 705 if the user has completed one or more tasks 703.

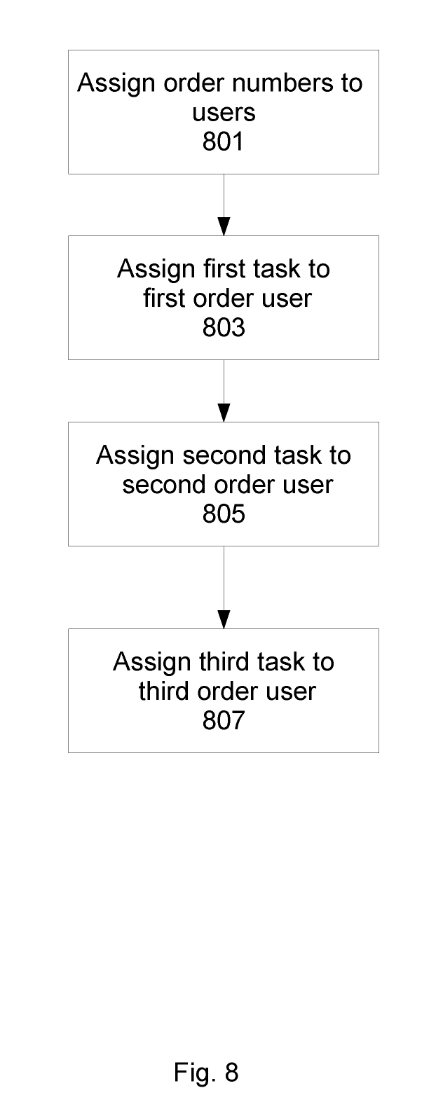

As show in FIG. 8, the system assign an order number to users 801, and assign a first unassigned task to a user assigned a first order number 803, assign a second unassigned task to a user assigned to a second order number 805, and then assign a third unassigned task to a user assigned to a third order number 807.

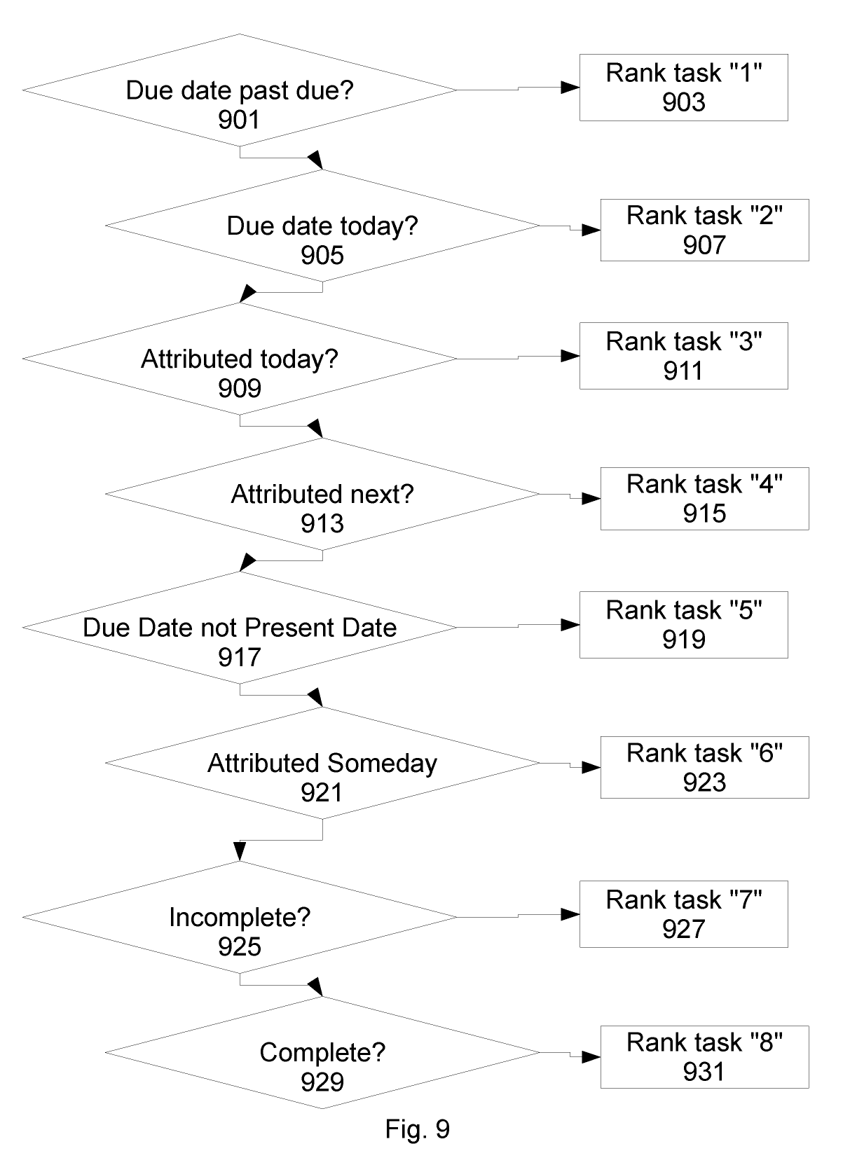

FIG. 9 shows an exemplary set of steps the system may take in ordering tasks. If the task has a due date that is past due 901, then rank that task as “1” 903. If the task has a due date that is today 905, then rank that task as “2” 907. If the task is attributed the Today attribute 909, then rank the task as “3” 911. If the task is attributed the Next attribute 913, then rank that task as “4” 915. If the task has a due date that is not the present calendar date 917, then rank the task as “5” 919. If the task is attribute the Someday attribute 921, then rank the task as “6” 923. If the task is active or incomplete 925, then rank the task as “7” 927. If the task is complete 929, then rank the task as “8” 929.

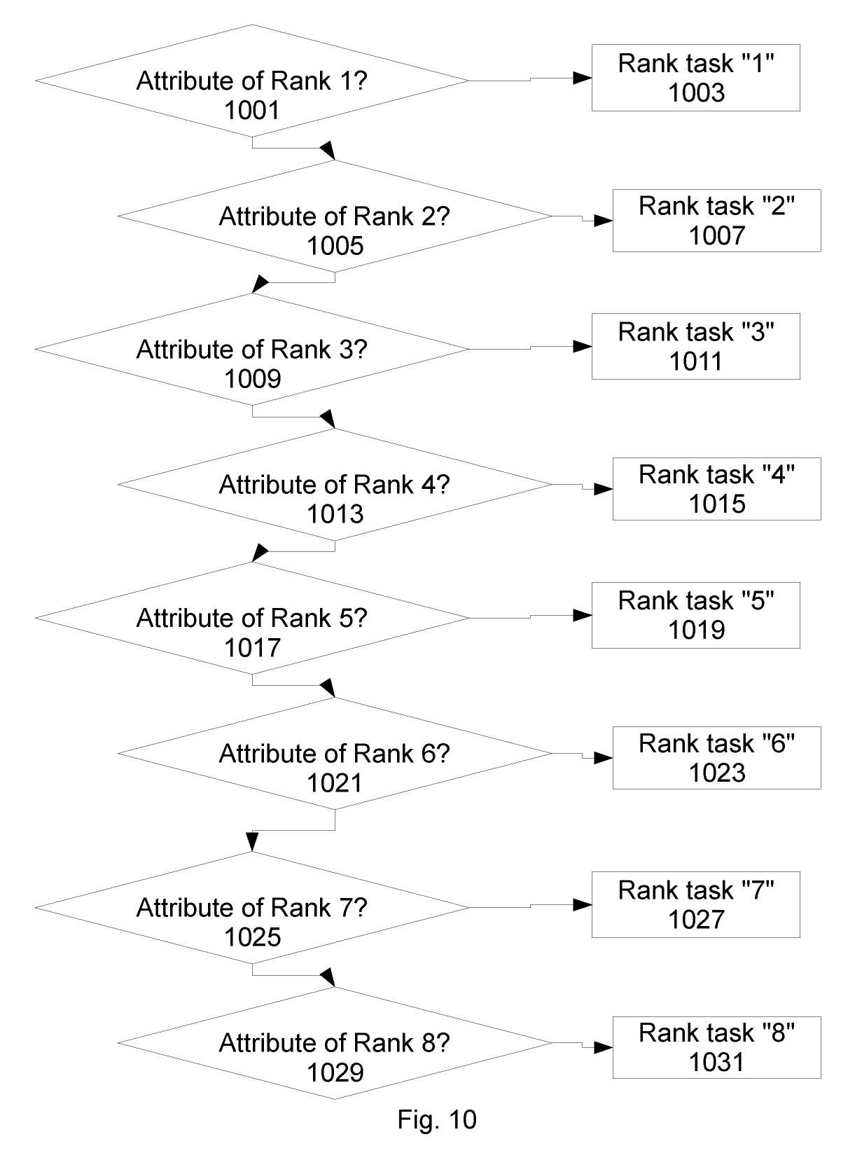

FIG. 10 shows another exemplary set of steps the system may take in ordering tasks. If the task is attributed with an attribute that is ranked “1” 1001, then the task is ranked “1” 1003. If the task is attributed with an attribute that is ranked “2” 1005, then the task is ranked “2” 1007. If the task is attributed with an attribute that is ranked “3” 1009, then the task is ranked “3” 1011. If the task is attributed with an attribute that is ranked “4” 1013, then the task is ranked “4” 1015. If the task is attributed with an attribute that is ranked “5” 1017, then the task is ranked “5” 1019. If the task is attributed with an attribute that is ranked “6” 1021, then the task is ranked “6” 1023. If the task is attributed with an attribute that is ranked “7” 1025, then the task is ranked “7” 1027. If the task is attributed with an attribute that is ranked “8” 1029, then the task is ranked “8” 1031.

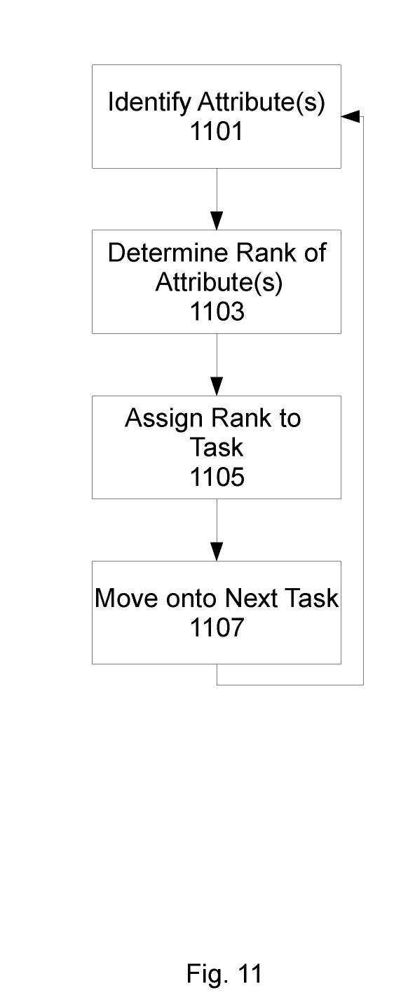

FIG. 11 shows another exemplary set of steps the system may take in ordering tasks. Identify the Attribute(s) attribute to a task 1101. Determine the rank of that Attribute on the Ranking List 1103. Assign that rank to the task 1105. If there is more than one Attribute, the rank of the highest ranking attribute may be assigned to the task. In one version, the ranks of the other attributes are also assigned so that tasks with the same rank can later be ordered based on the ranks of their other attributes. Move on to next task 1107. Repeat.

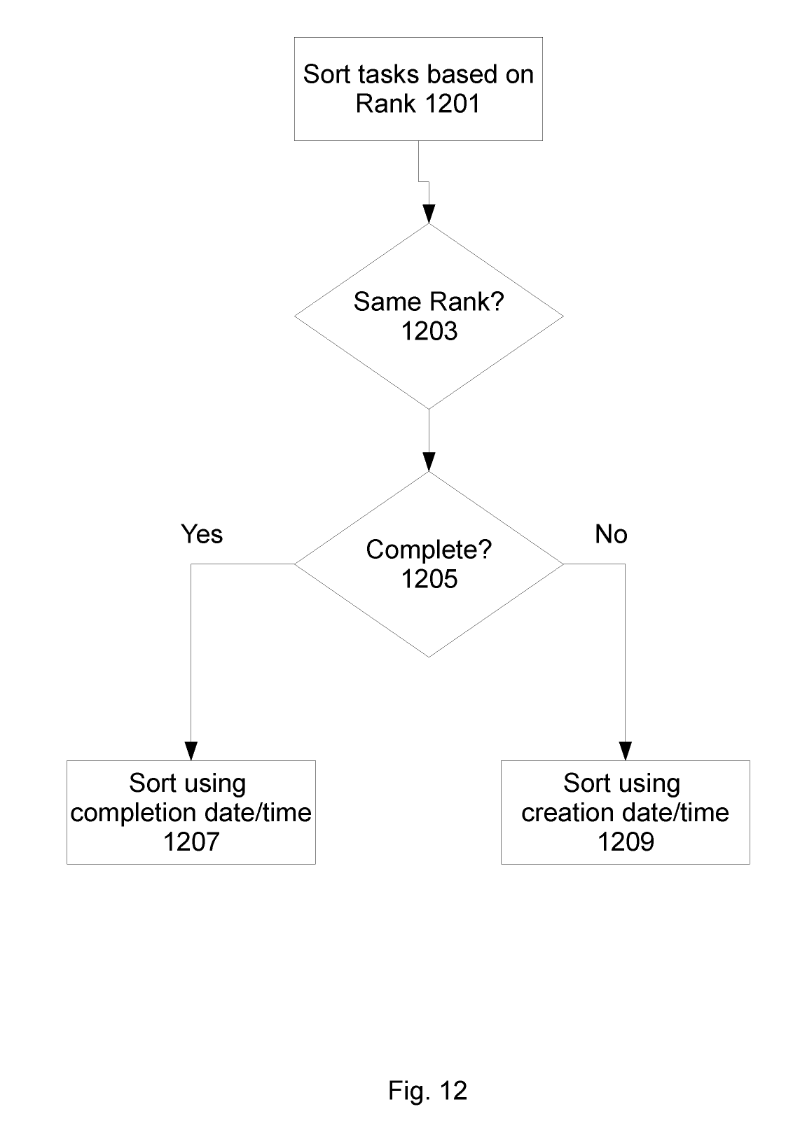

FIG. 12 shows an exemplary set of steps the system may take in ordering lists. Sort tasks based on rank 1201. If two or more tasks have the same rank 1203, determine whether tasks are complete or incomplete 1205. If they are complete sort the two or more tasks using the completion date/time 1207. If they are incomplete 1209, sort the two or more tasks using the creation date/time 1211.

1. A system comprising a plurality of computers, each computer having a computer-readable storage memory, a display device, one or more input devices, and access to a network, the computers programmed to:
(a) create a supervisory account for a first user, create a worker account for a second user, and create a worker account for a third user;
(b) receive user requests from the first user via one or more input devices connected to a first computer, receive user requests from the second user via one or more input devices connected to a second computer, and receive user requests from the third user via one or more input devices connected to a third computer;
(c) graphically display a first task window on a first display device, a second task window on a second display device, and a third task window on a third display device, where the first display device is connected to the first computer, the second display device is connected to the second computer, and the third display device is connected to the third computer;
(d) receive a request from the first user to create a first task, then graphically display a first task panel in the first task window;
(e) receive a first user generated text entry from the first user, then graphically display the first user generated text entry in the first task panel;
(f) receive a user request from the first user to assign a first attribute to the first task, then associate the first attribute with the first task and display a representation of the first attribute on the first task panel;
(g) receive a request from the first user to assign the first task to the second user, then graphically display the first task panel in the second task window;
(h) receive a user request from the first user to assign the second user to a first user group, then graphically display in the second task window all task panels associated with tasks assigned to users who have been assigned to the first user group;
(i) receive a request from the first user to create a second task, then graphically display a second task panel in the first task window;
(j) receive a second user generated text entry from the first user and graphically display the second user generated text entry in the second task panel;
(k) receive a request from the first user to assign the second task to the third user, then display the second task panel in the third task window;
(l) receive a user request from the first user to assign the third user to a second user group, then graphically display in the third task window all task panels associated with tasks assigned to users who have been assigned to the second user group;
(m)receive a user request from the first user to assign a second attribute to the second task, then associate the second attribute with the second task and graphically display a representation of the second attribute on the second task panel;
(n) if a user request to assign the second attribute to the first task is received, and the first task was already associated with the first attribute, then dissociate the first attribute from the first task and associate the second attribute to the first task;
(o) if a user request to assign the first attribute to the second task is received, and the second task was already associated with the second attribute, then dissociate the second attribute from the second task and associate the first attribute to the second task;
(p) receive a request from the first user via the one or more input devices to view a progress report, then graphically display the first task panel and the second task panel in a progress window and graphically display a representation of a first completion status on the first task panel and a representation of a second completion status on the second task panel;
(q) receive a message from the second user that the first task is complete, receive a message from the third user that the second task is complete, then display a third task panel in the second task window and a fourth task panel in the third task window; and
(r) determine the rank of each attribute using a first ranking regime and graphically display each of the tasks panels in an order according to the rank of the attributes associated with the tasks, but if two or more tasks are each assigned the same attributes, graphically display the task panels associated with those two or more tasks in an order according to an alphabetical listing of the user generated text entries.

2. A system comprising a plurality of computers, each computer having a computer-readable storage memory, a display device, one or more input devices, and access to a network, the computers programmed to:
(a) create a supervisory account for a first user, create a worker account for a second user, and create a worker account for a third user;
(b) receive user requests from the first user via one or more input devices connected to a first computer, receive user requests from the second user via one or more input devices connected to a second computer, and receive user requests from the third user via one or more input devices connected to a third computer;
(c) graphically display a first task window on a first display device, a second task window on a second display device, and a third task window on a third display device, where the first display device is connected to the first computer, the second display device is connected to the second computer, and the third display device is connected to the third computer;
(d) receive a request from the first user to create a first task, then graphically display a first task panel in the first task window;
(e) receive a first user generated text entry from the first user, then graphically display the first user generated text entry in the first task panel;
(f) receive a user request from the first user to assign a first attribute to the first task, then associate the first attribute with the first task and display a representation of the first attribute on the first task panel;
(g) receive a request from the first user to create a second task, then graphically display a second task panel in the first task window;
(h) receive a second user generated text entry from the first user and graphically display the second user generated text entry in the first task panel;
(i) receive a user request from the first user to assign a second attribute to the second task, then associate the second attribute with the second task and graphically display a representation of the second attribute on the second task panel;
(j) receive a request to assign the first task to the second user, then display the first task panel in the second task window;
(k) receive a request to assign the second task to the third user, then display the second task panel in the third task window; and
(l) determine the rank of each attribute using a first ranking regime and graphically display each of the tasks panels in an order according to the rank of the attributes associated with the tasks.

3. The system in claim 2, the computers additionally programmed to:
(a) if two or more tasks are each assigned the same attribute, graphically display the task panels associated with those two or more tasks in order according to an alphabetical listing of the user generated text entries.

4. The system in claim 3, the computers additionally programmed to:
(a) receive a user request from the first user to assign the second user to a first user group, then graphically display in the second task window all task panels associated with tasks assigned to users who have been assigned to the first user group; and
(b) receive a user request from the first user to assign the third user to a second user group, then graphically display in the third task window all task panels associated with tasks assigned to users who have been assigned to the second user group.

5. The system in claim 3, the computers additionally programmed to:
(a) if a user request to assign the second attribute to the first task is received, and the first task was already associated with the first attribute, then dissociate the first attribute from the first task and associate the second attribute to the first task; and
(b) if a user request to assign the first attribute to the second task is received, and the second task was already associated with the second attribute, then dissociate the second attribute from the second task and associate the first attribute to the second task.

6. The system in claim 3, the computers additionally programmed to:
(a) associate each attribute with an attribute panel;
(b) graphically display a ranking list window in the first display device;
(c) graphically display one or more attribute panels in the ranking list window, with each attribute panel having a unique graphical position;
(d) receive a user request from the first user to rearrange the graphical positions of one or more attribute panels;
(e) save the graphical positions of the one or more attribute panels as a second ranking regime;
(f) determine the rank of each attribute using the second ranking regime; and
(g) graphically display the tasks panels in the task windows in an order according to the rank of the attributes associated with the tasks.

7. The system in claim 2, the computers additionally programmed to:
(a) not to display task panels in order unless a user-generated sort request is received.

8. The system in claim 2, the computers additionally programmed to:
(a) graphically display a first representation of the first attribute on a first graphical position on the first task panel, and
(b) receive a user selection of the first representation, then cease graphically displaying the first representation and graphically display a second representation of the first attribute on the first graphical position on the first task panel.

9. The system in claim 2, the computers additionally programmed to:
(a) receive a request from the first user via the one or more input devices to view a progress report, then
(b) graphically display on the first display device a progress window, graphically display the first task panel and the second task panel in the progress window, and graphically display a representation of a first completion status on the first task panel and a representation of a second completion status on the second task panel.

10. The system in claim 2, the computers additionally programmed to:
(a) receive a message from the second user that the first task is complete, then display a third task panel in the second task window; and
(b) receive a message from the third user that the second task is complete, then display a fourth task panel in the third task window.

11. The system in claim 2, where in the first ranking regime,
(a) a “today” attribute is ranked 3, a “next” attribute is ranked 4, and a “someday” attribute is ranked 6.

12. A system comprising a first computer having a computer-readable storage memory, a first display device, and one or more input devices, the computer programmed to:
(a) graphically display a task window on the first display device;
(b) receive a user request via the one or more input devices to create a first task and graphically display a first task panel in the task window;
(c) receive a first user generated text entry via the one or more input devices and graphically display the first user generated text entry in the first task panel;
(d) receive a user request via the one or more input devices to assign a first attribute to the first task, then associate the first attribute with the first task and graphically display a representation of the first attribute on the first task panel;
(e) receive a user request via the one or more input devices to create a second task, then graphically display a second task panel in the task window;
(f) receive a second user generated text entry via the one or more input devices, then graphically display the second user generated text entry in the second task panel;
(g) receive a user request via the one or more input devices to assign a second attribute to the second task, then associate the second attribute with the second task and graphically display a representation of the second attribute on the second task panel; and
(h) determine the rank of each task using a ranking regime and graphically display the tasks panels in a line and according to the rank of the attributes associated with the tasks.

13. The system in claim 12, further comprising a second computer and a third computer, each of the second and third computer having a computer-readable storage memory, a display device, and one or more input devices, with the first, second, and third computer having access to one another.

14. The system in claim 13, the computers programmed to:
(a) create a supervisory account for a first user, create a worker account for a second user, and create a worker account for a third user;
(b) display a second task window on a second display device and a third task window on a third display device, the second display device connected to the second computer and the third display device connected to the third computer;
(c) receive requests from the first user to assign the second user to a first user group and assign the third user to a second user group, then graphically display in the second task window all task panels associated with tasks assigned to users who have been assigned to the first user group and graphically display in the third task window all task panels associated with tasks assigned to users who have been assigned to the second user group; and
(d) receive requests from the first user to assign the first task to the second user and assign the second task to the third user, then display the first task panel in the second task window and display the second task panel in the third task window.

15. The system in claim 13, where the ranking regime:
(a) ranks the following tasks in order:
i. a task with a due date that is past due;
ii. a task with a due date matching a current calendar date;
iii. a task assigned a “today” attribute;
iv. a task assigned a “next” attribute;
v. a task that has a due date that is later than the the current calendar date;
vi. a task that is assigned a “someday” attribute;
vii. a task that is incomplete; and
viii. a task that is complete as “8”.

16. The system in claim 15, where:
(a) if a task would have two ranks, the ranking regime will rank the task using the higher of the two ranks.

17. The system in claim 16, where:
(a) if two tasks would have the same rank, the ranking regime will rank the two tasks based on their alphabetical order.

18. The system in claim 2, where
(a) a current calendar date is determined; and
(b) a task with a due date that is past due is ranked 1, a task with a due date matching the current calendar date is ranked 2, a task assigned a “today” attribute is ranked 3, a task assigned a “next” attribute is ranked 4, a task that has has a due date that is later than the the current calendar date is ranked 5, a task that is assigned a “someday” attribute is ranked 6, a task that is incomplete is ranked 7, and a task that is complete is ranked 8.

19. The system in claim 2, the computers programmed to:
(a) assign each task a rank using the rank of the one or more attributes assigned to each task.

20. The system in claim 13, the computers additionally programmed to:
(a) graphically display a first representation of the first attribute on a first graphical position on the first task panel, and
(b) if a user selection of the first representation is received, then cease graphically displaying the first representation and graphically display a second representation of the first attribute on the first graphical position on the first task panel.
